(19) United States
(12) Patent Application Publication
(10) Pub. No.: US 2026/0220478 A1
(43) Pub. Date: Jul. 30, 2026

(54) SYSTEMS AND METHODS FOR LONG-FORM REASONING IN LARGE LANGUAGE MODELS

(71) Applicant: Salesforce, Inc., San Francisco, CA (US)

(72) Inventors: Bo Pang, Los Angeles, CA (US); Hanze Dong, Singapore (SG); Jiacheng Xu, Sunnyvale, CA (US); Silvio Savarese, Palo Alto, CA (US); Yingbo Zhou, Palo Alto, CA (US); Caiming Xiong, Menlo Park, CA (US)

(21) Appl. No.: 19/287,467

(22) Filed: Jul. 31, 2025

Related U.S. Application Data
(60) Provisional application No. 63/751,485, filed on Jan. 30, 2025.

(51) Int. Cl. G06N 3/092; G06N 3/0475

(52) U.S. Cl. CPC G06N 3/092; G06N 3/0475

(57) ABSTRACT

Embodiments described herein provide a training framework that trains an LLM to generate long reasoning by using synthesized reasoning data from a LLM with shorter reasoning, all without knowledge distillation from a long-reasoning ready LLM. Specifically, an LLM that is not pretrained with long reasoning data may generate multiple sample responses to an input prompt combining an input query and a set of long-reasoning examples as context to the input query. The generated sample responses each includes an associated long reasoning sequence and a respective final answer. The training framework filters the generated sample responses using an outcome reward model depending on accuracy of the final answers. The training framework then trains LLM using the filtered generated sample responses as training data for long reasoning. The training framework may refine the LLM by online training using new unseen queries.

### CROSS REFERENCE(S)

The instant application is a nonprovisional of and claims priority under 35 U.S.C. 119 to U.S. provisional application No. 63/751,485, filed on Jan. 30, 2025, which is hereby expressly incorporated by reference in its entirety.

### TECHNICAL FIELD

The embodiments relate generally to machine learning systems for training large language models (LLMs), and more specifically to training LLMs to generate long-form reasoning, also referred to herein as long chain-of-thought (LongCoT) reasoning.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Large language models (LLMs), such as OpenAI's o1 model, have exhibited extraordinary reasoning abilities particularly on coding and mathematical problems. The o1 model employs long-form reasoning, which involves generating an extended output sequence explaining a reasoning process that arrives at a final answer prior to delivering the final answer. This type of long-form reasoning is also known as long chain-of-thought (LongCoT) reasoning, which is characterized by the ability to analyze problems, make plans, branch to different approaches, evaluate their reasoning through reflection, and, when necessary, backtrack to correct errors. By leveraging these problem-solving techniques via long chain-of-thought, LLMs can tackle highly intricate and multifaceted challenges, showcasing their potential to function as powerful tools for complex reasoning tasks across various disciplines.

However, existing methods for enabling long-form reasoning in LLMs often rely on knowledge distillation from pretrained models that already exhibit the capabilities of long-form reasoning. These approaches depend on access to large, high-quality reasoning datasets or expert models, making them resource-intensive and difficult to scale. Accordingly, there is a need for techniques that enable long-form reasoning without relying on pre-existing LongCoT models, training data, or other forms of prior LongCoT supervision.

### BRIEF DESCRIPTION OF THE DRAWINGS

FIG. 1 shows an example operation of an LLM-based AI agent, according to embodiments of the present disclosure.

FIG. 2 is a simplified diagram illustrating a LongCoT training framework, according to some embodiments.

FIG. 3 illustrates an example LongCoT answer that can be used as an in-context reasoning example, according to some embodiments.

FIG. 4 illustrates an example prompt used to generate long-form reasoning from a language model that has not been trained on such reasoning, as part of the LongCoT training framework shown in FIG. 2, according to some embodiments.

FIG. 5 illustrates an example LongCoT answer generated by a trained LLM using the LongCoT training framework shown in FIG. 2, according to some embodiments.

FIG. 6A is a simplified diagram illustrating a computing device implementing the LongCoT training framework described in FIGS. 2-5, according to some embodiments.

FIG. 6B is a simplified diagram illustrating a neural network structure, according to some embodiments.

FIG. 7 is a simplified block diagram of a networked system suitable for implementing the LongCoT training framework described in FIGS. 2-5 and other embodiments described herein.

FIG. 8 is an example logic flow diagram illustrating a method of training a neural network language model to generate extended chain-of-thought reasoning based on the framework shown in FIGS. 2-5, according to some embodiments.

FIG. 9 provide graphs illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

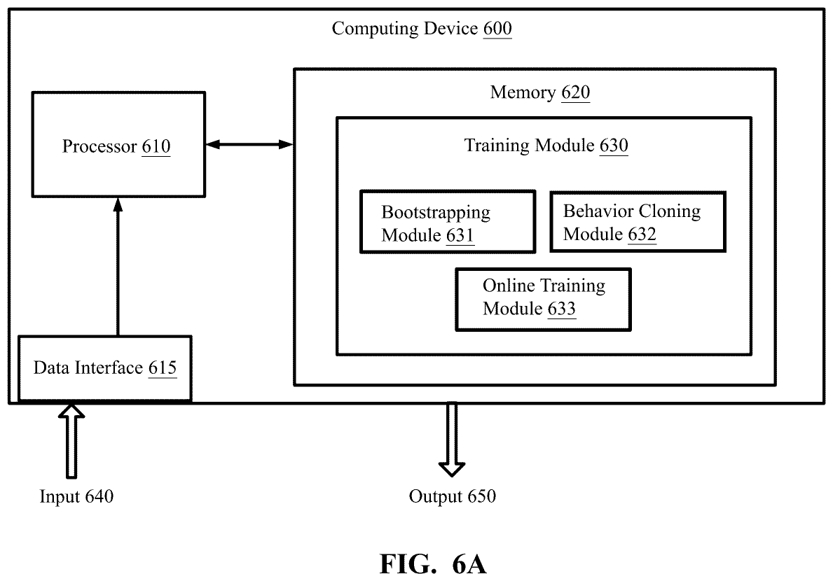

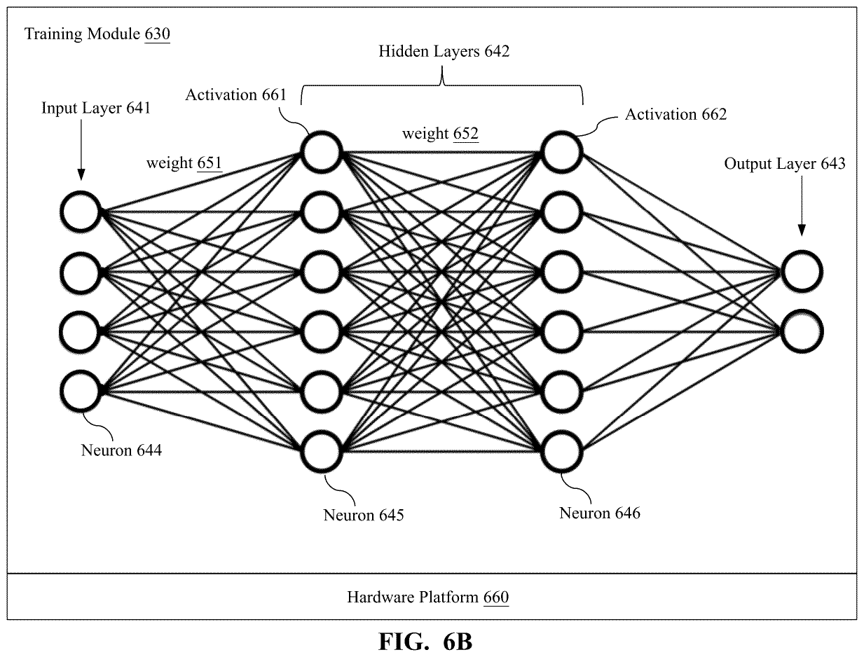

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Large language models (LLMs) may be trained or fine-tuned to generate an extended output sequence that include reasoning steps alongside a final answer to an input query. Some LLMs that are smaller in size (e.g., fewer layers, fewer weights, and/or the like) may only be limited to generate a short reasoning sequence compared to other larger LLMs (e.g., OpenAI-o1, Qwen-QwQ, DeepSeek-R1), which have been trained to generate long sequences of detailed reasoning to address problems that require multi-step deductions, integrating various types of information, or handling ambiguity.

For example, for an AI agent to address a network issue such as “user losing access to the internal file server,” the AI agent may go through a multi-step diagnostic and analytical process: the AI agent generates a script to query authentication logs and network telemetry for IP addresses and session timestamps of the affected users, then executes diagnostic routines to test network connectivity, VPN status, and DNS resolution from those endpoints. Simultaneously, the AI agent pulls recent changes from access control systems, such as group policy updates or permission modifications in Active Directory. If a policy change is detected, the AI agent correlates its timestamp with the onset of access failures and simulates a rollback in a sandbox to verify if access is restored. Upon confirming the root cause, the AI agent composes and submits a change request or directly applies the fix if permitted. Finally, the AI agent logs the incident, updates anomaly detection models, and modifies its response templates to improve future diagnostics—this layered, adaptive long-form reasoning through code generation, log correlation, and policy remediation. This long-form chain-of-thought reasoning may be characterized by, and may incorporate, problem analysis, planning, branching, backtracking, and reflection, which is also referred to as long reasoning, long-form reasoning, long chain-of-thought (LongCoT) reasoning, or the like.

To train smaller LLMs in long-form reasoning, sequences of extended reasoning generated by larger, pretrained LLMs can be used as training data-a process known as knowledge distillation. This approach enables smaller models to perform complex reasoning tasks while requiring significantly fewer computational resources. However, relying on knowledge distillation leaves substantial uncertainties on how to systematically develop such advanced reasoning skills. For example, there is no independent control of how to train these smaller LLMs without first training or obtaining a high-quality teacher model (e.g., long-reasoning ready LLMs), which is expensive and time-consuming. Further, after training or obtaining such a teacher model, the student model (e.g., smaller LLMs with shorter reasoning capabilities) may replicate outputs without fully understanding the reasoning process of the teacher, resulting in less reliable or uncertain outputs.

In view of the need for efficiently training LLMs for long reasoning, embodiments described herein provide a LongCoT training framework that trains an LLM to generate long reasoning by using synthesized reasoning data from a LLM with shorter reasoning, all without knowledge distillation from a long-reasoning ready LLM. Specifically, an LLM that is not pretrained with long reasoning data may generate multiple sample responses to an input prompt combining an input query and a set of long-reasoning examples as context to the input query. The generated sample responses each includes an associated long reasoning sequence and a respective final answer. The training framework filters the generated sample responses using an outcome reward model depending on accuracy of the final answers. The training framework then trains LLM using the filtered generated sample responses as training data for long reasoning. The training framework may refine the LLM by online training using new unseen queries.

Embodiments described herein provide a number of benefits. The LongCoT training framework enables long-form reasoning on smaller LLMs (e.g., those with shorter reasoning capabilities than foundation models such as GPT-40), all without relying on pre-existing LongCoT models, training data, or other forms of prior LongCoT supervision. Instead, long-form reasoning capabilities can be developed from scratch with only a few in-context examples (e.g., 10), thereby overcoming significant data requirements required in knowledge distillation methods. With improved long-form reasoning training techniques using small-scale LLMs, computational and hardware efficiency of neural network technology is improved.

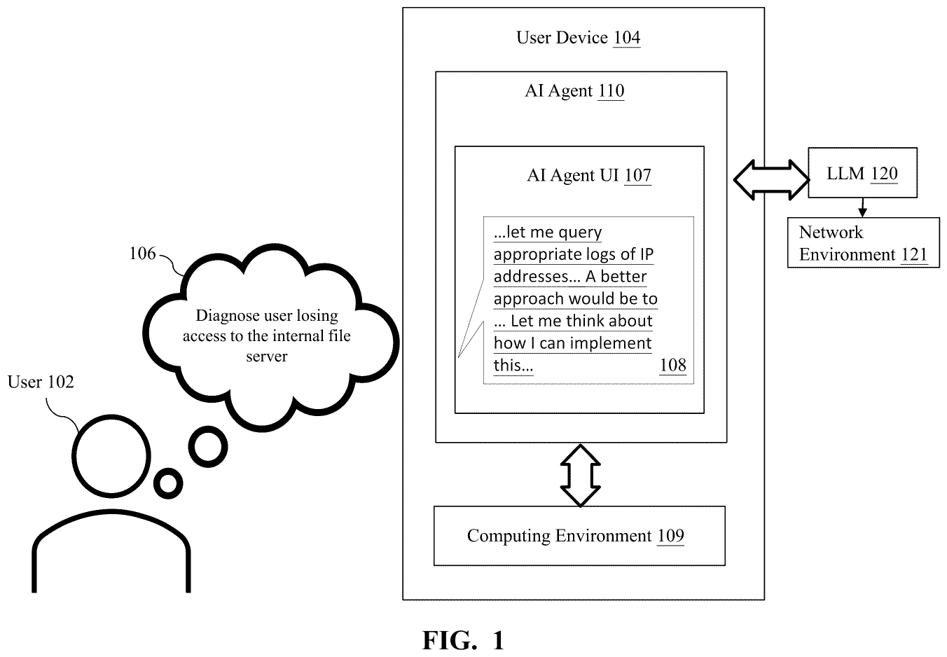

FIG. 1 shows an example operation of an LLM-based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to address a network issue such as to “diagnose user losing access to the internal file server” 106.

In one embodiment, the AI agent 110 may process the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, such as in the form of a specific type of reasoning (e.g., LongCoT), suggested code program, text description, etc. The LLM 120 may in turn generate a response 108 based on an input combining the task request 106 and any system prompt.

The response 108 may include instructions, explanations, code scripts or direct actions to address the task request 106. In the embodiment shown, the response 108 may include LongCoT reasoning (which may involve reflection and backtracking) to show detailed steps of reasoning before arriving at an answer. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104. The LLM 120 may also output to a network environment 121 for further processing.

For example, when the user 102 requests to solve a problem (e.g., a math problem, a network diagnostic problem, a coding problem, etc.), the LLM 120 may output a code script to execute on the computing environment 109 (e.g., a network management application, a browser application, a programming terminal application, etc.) on the user device 104 to solve the problem and/or perform other automated follow-up tasks based on completing the solved problem (e.g., update code in database, run scripts based on updated code, execute diagnostic routines, etc.). The LLM 120 may also generate code scripts that interface with APIs of other applications within the computing environment 109 to carry out the requested tasks.

In this way, the LLM-based AI agent may facilitate end-to-end workflow to automate the task request 106. However, some LLMs may lack the reasoning capabilities (e.g., LongCoT) required to solve certain problems or fulfill complex task requests. These LLMs may need to be trained prior to deployment. Embodiments described herein provide systems and methods to train such LLMs prior to their deployment as AI agents, as further described in the figures below.

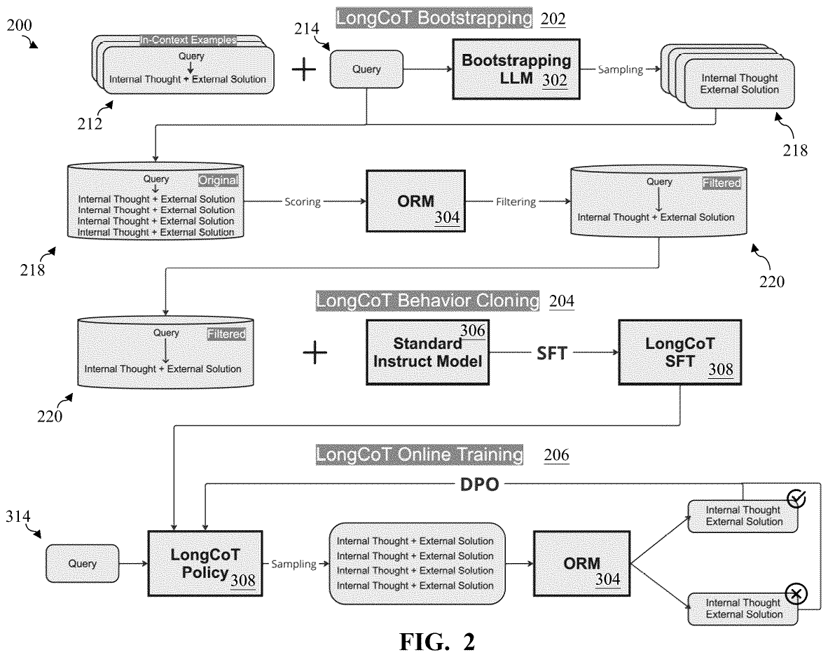

FIG. 2 is a simplified diagram illustrating a LongCoT training framework 200, according to some embodiments. The framework 200 comprises a three-stage pipeline. In the first stage 202 (labeled as LongCoT Bootstrapping), an LLM 302 that has not been trained on long-form reasoning (also referred to as a bootstrapping LLM) is used to synthesize long-form reasoning data 218 from input queries and a small number of in-context examples 212. The in-context examples 212, which may be defined by a triplet of query, reasoning, and solution, guide the LLM 302 in generating long-form reasoning data. At the second stage 204 (labeled as LongCoT Behavior Cloning), the synthesized long-form reasoning data is used as training data to train and/or finetune a target LLM 306 (which can be the bootstrapping LLM or another LLM). The target LLM 306 is trained to adapt to and practice extended chain-of-thought reasoning before arriving at a solution. At the third stage 206 (labeled as LongCoT Online Training), the trained target LLM is further trained through online exploration and refinement on new unseen queries, such as through a direct preference optimization (DPO) feedback loop. In the present embodiments, both the bootstrapping LLM 302 and the target LLM 306 are LLMs that have not been previously trained on long-form reasoning. In an embodiment, each of the bootstrapping LLM and target LLM are LLMs having fewer than 70 billion parameters.

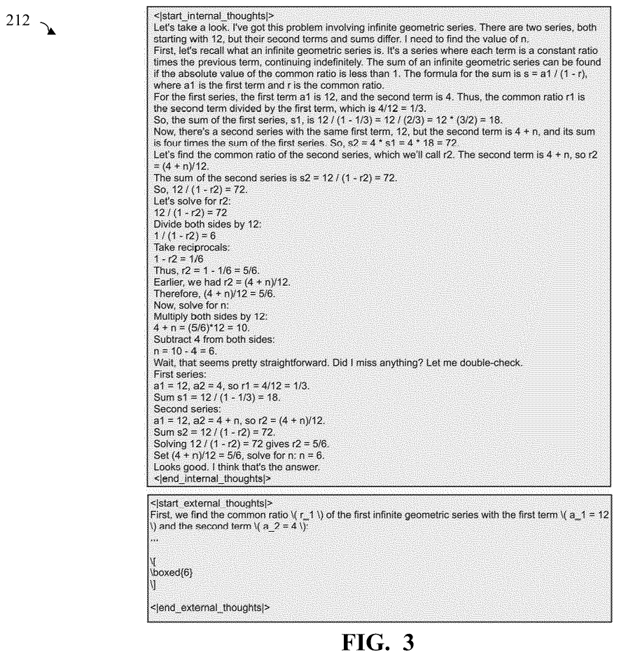

Referring to the first stage 202 in more detail, in-context examples 212 (e.g., a triplet of query, reasoning and solution) and a query 214 are used as inputs into a bootstrapping LLM 302. The in-context examples 212 act as guides for the bootstrapping LLM 302 to generate long-form chain-of-thought reasoning in response to the input query 214. For example, each in-context example 212 may include an example query (x)-different from query 214, a long-form chain-of-thought reasoning (z), and a corresponding solution (y) derived from the reasoning process. The collection of in-context examples 212 is denoted as D_{ICL}={(x, y, z)}. The in-context examples 212 may be manually authored, taken from existing datasets, or generated by an AI model and subsequently refined through human review. Notably, only a small number of in-context examples 212 (e.g., 10 or less) is needed, thereby overcoming significant data requirements required in knowledge distillation methods. An example in-context example 212 is shown in FIG. 3, which illustrates various intermediate steps and reasoning for solving an example math problem. For example, the top block in FIG. 3 may represent the internal reasoning steps z, while the bottom block may represent the corresponding external solution y; the query x is not shown.

Referring back to FIG. 2, the query 214 may be generated through a query curation pipeline that includes (1) query collection, (2) difficulty scoring and filtering, and (3) topic tagging and sub-sampling. During query collection, queries across multiple task domains are collected (e.g., business and finance, creative writing, philosophy, health and medicine, math, science, coding, etc.). These queries may be collected from instruction datasets from public sources, such as ShareGPT, SlimOrca, MathInstruct, etc. Only the query of each data instance is retained. Then, the collected queries are scored and filtered to form a curated set having scores above a threshold indicating the queries are sufficiently difficult and require long-form reasoning. Then, the curated set is tagged and subsampled to generate a final set of queries, denoted as D_{b-query}={x}. The final set of queries may comprise a higher proportion of instruction-type queries directed to math and coding tasks relative to other instruction types (e.g., business and finance, creative writing, etc.).

Still referring to FIG. 2, given a set of in-context examples 212 (D_{ICL}={(x, y, z)}) and a final set of queries 214 (D_{b-query}={x}), the bootstrapping LLM 302 (M_{bootstrapping}) generates n reasoning responses 218 (y, z) for each query x such that

$$( y , z ) \sim {ℳ}_{bootstrapping} ( y , z ) \vert {f}_{formatting} ( x , {\tilde{𝒟}}_{ICL} ) ) ,$$

where x~D_{b-query}, \tilde{D}_{ICL} is a subset of D_{ICL}, and formatting is a template that wraps x and \tilde{D}_{ICL} as an LLM input prompt.

For each query x of the final set of queries D_{b-query}, n sample candidate responses are generated using a subset \tilde{D}_{ICL} in-context examples. In one embodiment, n is set to 8 and \tilde{D}_{ICL} includes 3 in-context examples selected from a total of 10 available in-context examples 212. In this case, for each query 214, 8 reasoning responses are generated based on 3 selected in-context examples. The resulting sampled responses 218 may be denoted as:

$${𝒟}_{bootstrapping}^{( original )} = \{ ( x , {\{ {y}_{i} , {z}_{i} \}}_{i = 1}^{n} \} ) .$$

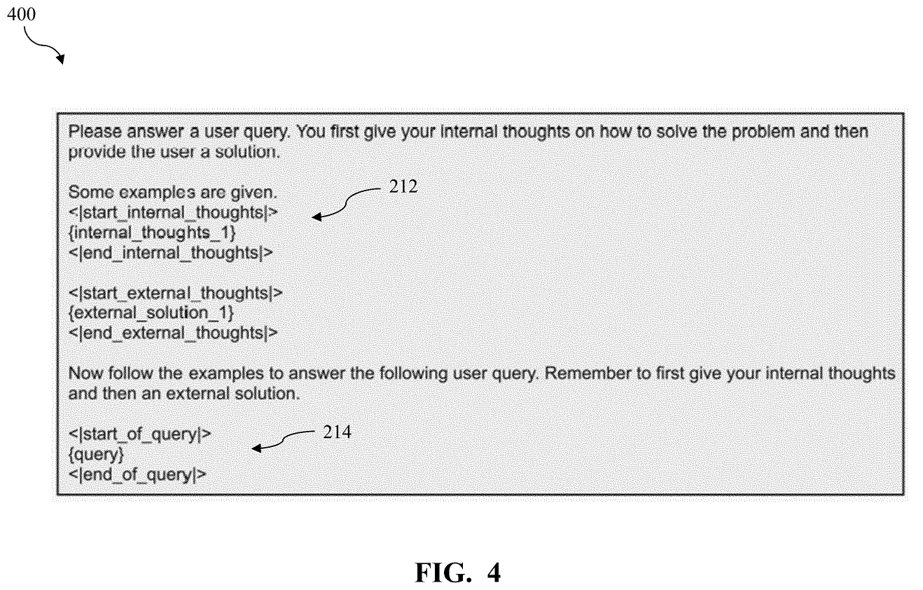

FIG. 4 illustrates an example input prompt 400 that is constructed for use by the bootstrapping LLM 302 to generate n reasoning responses 218 (y, z). As shown, the input prompt 400 includes one or more in-context examples 212 and a user query 214.

Referring back to FIG. 2, the first stage 202 includes scoring and filtering the sampled responses 218 to select a single filtered reasoning response 220 for each query x. For example, when n=8, one filtered reasoning response 220 is selected from a set of eight generated reasoning responses 218. In an embodiment, the sampled responses 218 are evaluated and scored using a reward model 304 indicating output quality. The reward model 304 may comprise a large language model trained to estimate the correctness of a final solution (e.g., y) based on the reasoning path (z) that leads to it. In one embodiment, the reward model 304 is implemented as an outcome reward model (ORM), which assigns a score based primarily on whether the final answer is correct, without requiring the reward model to evaluate or understand the full reasoning process. The assigned reward scores are used to rank the sampled responses 218, and a highest-scoring response that exceeds a predefined reward threshold is selected as the filtered reasoning response 220 for training. This scoring and filtering process may be performed for multiple queries, and the resulting filtered reasoning responses 220 may collectively be denoted as D_{bootstrapping}={(x, y, z)}.

Referring now to the second stage 204 in more detail, the filtered reasoning responses 220 generated in the first stage 202 may be used as training data to train a target LLM 306, which may be a pre-trained standard instruct model initially lacking long-form reasoning capabilities. The training may be performed through supervised finetuning, using the input queries and their corresponding filtered reasoning responses (e.g., triplets of the form (x, y, z)) as ground truth data representative of long-form reasoning. This finetuning step enables the target LLM 306 to learn how to generate more detailed, multi-step reasoning paths (z) along with final solutions (y), thereby extending its capabilities beyond short-form or single-step reasoning.

In some embodiments, the bootstrapping language model 302 and the target LLM 306 may be the same model, such as in a self-bootstrapping configuration. In this case, the model first generates candidate reasoning responses 218 using in-context prompting and is subsequently refined through supervised training on its own filtered outputs 220. In one embodiment, the bootstrapping LLM 302 comprises LLAMA-3.1-70B, which is used to generate training data for itself.

In other embodiments, the bootstrapping LLM 302 and the target LLM 306 may be different models. For example, a larger model may be used for bootstrapping (due to its enhanced processing capabilities), while a smaller model is selected as the target for supervised finetuning to support more efficient deployment. In one embodiment, LLaMA-3.1-70B is used as the bootstrapping LLM 302 to generate filtered training data 220 for a target LLM 306 such as LLAMA-3.1-8B or Mistral-7B.

After supervised tuning, an initially trained LLM 308 is produced. This trained model incorporates the long-form reasoning capabilities learned from the filtered training data 220 generated in the first stage 202. This initial trained LLM 308 may serve as the foundation for further refinement, evaluation, or deployment, depending on the application context.

Referring now to the third stage 206 in more detail, the initially trained LLM 308 may be further trained and refined using new, previously unseen queries 314. In this stage, the initially trained LLM 308 generates one or more candidate reasoning responses for each new input query 314, without relying on in-context reasoning examples 212. The generated responses are then evaluated using a reward model (e.g., reward model 304), which assigns reward scores indicative of output quality, such as correctness or alignment with desired reasoning format.

In one embodiment, a pair of responses is selected for each query: a higher-scoring response and a lower-scoring response, based on the assigned reward scores. These response pairs are used to further train the model 308 through a preference-based optimization algorithm. For example, direct preference optimization (DPO) may be applied to adjust the model weights such that the likelihood of generating the higher-scoring response is increased relative to the lower-scoring one. This online refinement process enables continued improvement of long-form reasoning capabilities using model-generated data, without the need for additional manually labeled supervision.

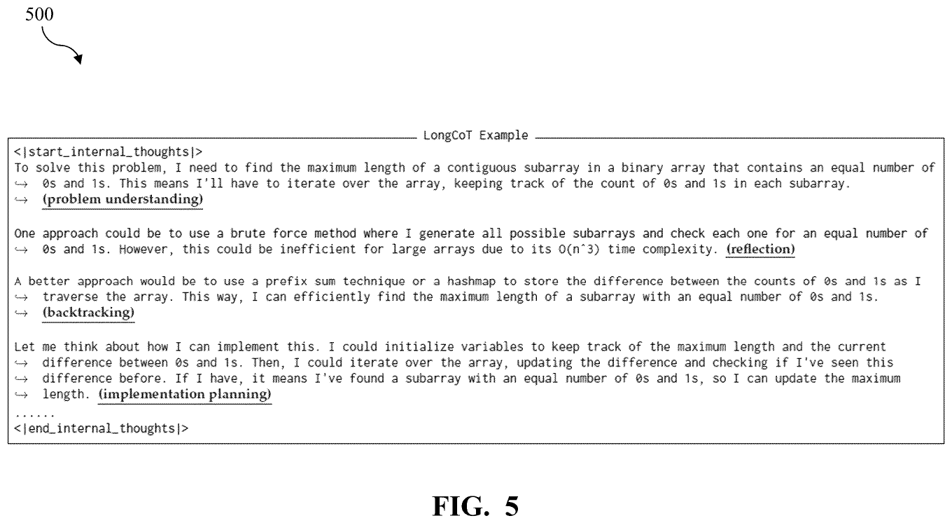

After the third stage 206, the trained LLM 308 may be deployed as an AI agent, such as AI agent 110 previously described. Referring to FIG. 5, the AI agent may generate long-form reasoning answers, such as example answer 500 produced by the trained LLM 308 using the training framework 200. As shown, the example answer 500 exhibits key characteristics of long-form reasoning learned during training, including problem understanding, reflection, backtracking, and implementation planning.

In this way, the entire training framework 200 may output a trained LLM 308 for LongCoT without employing any foundation LLM that has been pretrained on LongCoT reasoning data. Without the complex LongCoT training on large foundation LLMs (such as GPT-40 having 160 billions parameters), trained LLM 308 is obtained with computational and hardware efficiency.

### Computer and Network Environment

FIG. 6A is a simplified diagram illustrating a computing device implementing the training framework 200 described in FIGS. 25, according to one embodiment described herein. As shown in FIG. 6A, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for training module 630 that may be used to implement and/or emulate the systems and models, and/or to implement any of the methods described further herein. Training module 630 may receive input 640 such as an input training data (e.g., in-context examples, filtered queries, filtered sampled responses, etc.) via the data interface 615 and generate an output 650 which may be a long-form reasoning answer.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as in-context examples, filtered queries, filtered sampled responses, etc., from a user via the user interface.

In some embodiments, the training module 630 is configured to synthesize sample long-form reasoning responses from initial input queries and in-context examples, train a target LLM based on filtered reasoning responses, and train the target LLM on new unseen queries. The training module 630 may further include submodules such as bootstrapping module 631 (e.g., configured to execute the first stage 202), behavior cloning module 632 (e.g., configured to execute the second stage 204), and online training module 633 (e.g., configured to execute the third stage 206).

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the training module 630 described in FIG. 6A, according to some embodiments. In some embodiments, the training module 630 and/or one or more of its submodules 631-633 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as in-context examples and a set of filtered queries. The number of nodes (neurons) in the input layer 641 may be determined by the dimensionality of the input data (e.g., the length of a vector of the input queries, in-context examples, and other prompts). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the training module 630 receives an input 640 of input queries and a small number of in-context examples and transforms the input into an output 650 of a long-form reasoning answer (through various stages of training). To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the training module 630 and/or one or more of its submodules 631-633 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a recurrent neural network, a convolutional neural network, and/or the like.

In one embodiment, the training module 630 and its submodules 631-633 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the training module 630 and its submodules 631-633 may be implemented by hardware, software and/or a combination thereof. For example, the training module 630 and its submodules 631-633 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the training module 630 and its submodules 631-633 (e.g., bootstrapping LLM 302, target LLM 306, and/or reward model 304) and/or any other neural network models onto hardware platform 660, the neural network based modules 630 and its submodules 631-633 may be optimized for deployment by converting it to a suitable format, such as ONNX or TensorRT, to improve performance and compatibility. Next, depending on the size and workload requirements for modules 630 and its submodules 631-633, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the training module 630 and its submodules 631-633 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the training module 630 and its submodules 631-633 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the training module 630 and its submodules 631-633 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the training module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based training module 630 and one or more of its submodules 631-633 may be trained by iteratively updating the underlying parameters (e.g., weights 651, 652, etc., bias parameters and/or coefficients in the activation functions 661, 662 associated with neurons) of the neural network based on a loss. For example, during forward propagation, the training data such as input data 640 is fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding long-form reasoning answer of a previously generated filtered reasoning response 220) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based training module 630 and one or more of its submodules 631-633 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

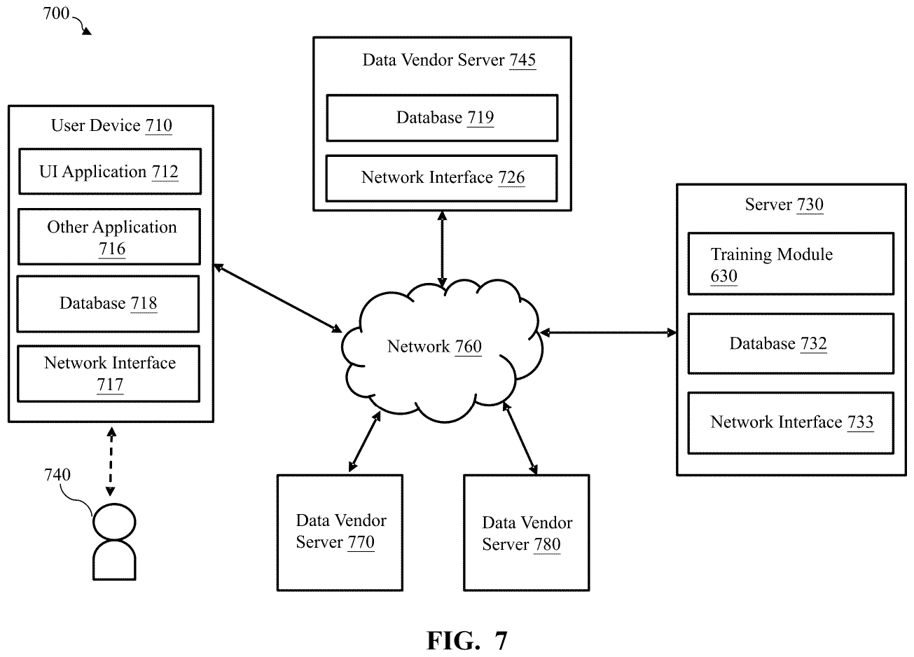

In some embodiments, training module 630 and its submodules 631-633 may be housed at a centralized server (e.g., computing device 600) or one or more distributed servers. For example, one or more of training module 630 and its submodules 631-633 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as on new unseen coding and math tasks.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. These updates are driven by exposure to training inputs and corresponding outputs during supervised or preference-based learning. As a result, the trained neural network acquires new capabilities (e.g., the ability to perform long-form reasoning without relying on traditional knowledge distillation techniques). The improved performance of the trained neural network contributes to the advancement of neural network technology, particularly in enabling more autonomous, scalable, and interpretable reasoning in large language models.

FIG. 7 is a simplified block diagram of a networked system 700 suitable for implementing the training framework 200 described in FIGS. 2-5 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating long-form reasoning from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the training module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which training module 630 may generate a response via various processes described herein. The training module 630 may thus cause a display of a long-form reasoning answer at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view various long-form reasoning answers.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including queries and in-context examples to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the training module 630 and its submodules described in FIG. 6A. In some implementations, training module 630 may receive data from database 719 at the data vendor server 745 via the network 760 to generate sets of queries. The generated queries may also be sent to the user device 710 for review by the user 740 via the network 760 (e.g., for further filtering and curation).

In one embodiment, an AI agent implementing the training module 630 and its submodules described in FIG. 6A may be built based on an LLM as described in FIG. 6B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the training module 630 and its submodules described in FIG. 6A may be implemented as a cloud-based AI agent which may be accessed by user device 710 via a chatbot application, a web application, customer support or SaaS applications. In another implementation, a client-side AI agent component may be delivered from the server 730 to user device 710 for local installation such that the client-side AI agent may be installed and runs directly on the user's device. Such local AI agent on the user device 710 may be available offline to adapt to privacy-sensitive applications. In another implementation, the AI agent implementing the training module 630 and its submodules described in FIG. 6A may adopt a hybrid cloud and client-based structure to balance computing speed, cost and privacy. For example, a local AI agent may handle basic AI queries locally, but complex queries may be sent to server 730 to process.

The database 732 may be stored in a transitory and/or non-transitory memory of the server 730. In one implementation, the database 732 may store data obtained from the data vendor server 745. In one implementation, the database 732 may store parameters of the training module 630. In one implementation, the database 732 may store previously generated long-form reasoning responses and associated queries, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

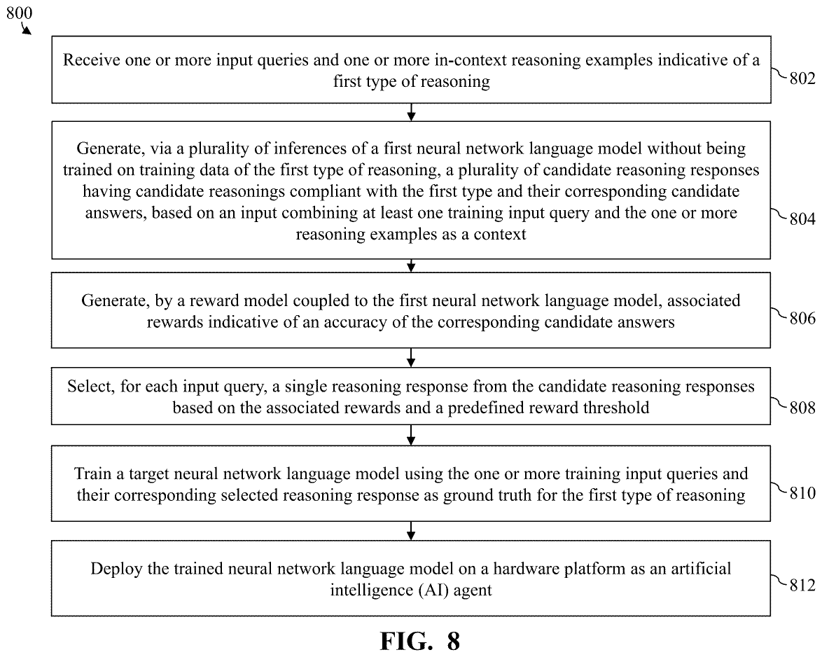

FIG. 8 is an example logic flow diagram illustrating a method 800 of training a neural network language model (e.g., target LLM 306) to generate extended chain-of-thought reasoning based on the framework 200 shown in FIGS. 2-5, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the training module 630 (e.g., FIGS. 6A, 6B, and 7) that synthesize sample long-form reasoning responses from initial input queries and in-context examples (e.g., first stage 202), train a target LLM based on filtered reasoning responses (e.g., second stage 204), and train the target LLM on new unseen queries (e.g., third stage 206).

In some embodiments, method 800 is performed by a system such as computing device 600, user device 710, server 730, or another device or combination of devices. Inputs (e.g., in-context examples 212, queries 214, etc.) may be received via a data interface such as data interface 615, network interface 717, network interface 733, or via a data interface that is integrated with a device. For example, UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, the method receives one or more training input queries (e.g., queries 214) and one or more in-context reasoning examples (e.g., in-context examples 212) indicative of a first type of reasoning (e.g., long-form reasoning).

At step 804, the method generates, via a plurality of inferences of a first neural network language model (e.g., bootstrapping LLM 302) without being trained on training data of the first type of reasoning, a plurality of candidate reasoning responses having candidate reasonings compliant with the first type and their corresponding candidate answers, based on an input combining at least one training input query and the one or more reasoning examples as a context. For example, the method generates, using a bootstrapping language model that is not trained on training data of the first type of reasoning, a plurality of candidate reasoning responses with associated answers by prompting the bootstrapping language model with at least one input query and the in-context reasoning examples as a prompt.

In an embodiment, the first type of reasoning (e.g., long-form reasoning) includes a sequence of tokens longer than a first threshold, while a second type of reasoning (e.g., short-form reasoning) includes a sequence of tokens shorter than the first threshold. The first threshold may be defined based on the total number of tokens in the corresponding solution and/or the number of reasoning steps. For example, the threshold may require that the reasoning sequence contains at least twice as many tokens as the solution. In another example, the sequence may exceed a predefined minimum number of reasoning steps, such as at least four steps. In a further embodiment, the reasoning steps may additionally include reasoning behaviors such as reflection and/or backtracking.

At step 806, the method generates, by a reward model (e.g., reward model 304) coupled to the first neural network language model, associated rewards indicative of an accuracy of the corresponding candidate answers. For example, the reward model evaluates the candidate reasoning responses using the reward model to assign reward scores indicating output quality.

At step 808, the method selects, for each input query, a single reasoning response (e.g., filtered reasoning response 220) from the candidate reasoning responses based on the associated rewards and a predefined reward threshold. For example, there may be 8 candidate reasoning responses from each query, and the method at step 808 selects a single reasoning response from the 8 based on associated reward scores and a predefined reward threshold.

At step 810, the method trains a target neural network language model (e.g., target LLM 306) using the one or more input queries and their corresponding selected reasoning responses as ground truth for the first type of reasoning. The method at step 810 may perform further online training on new unseen queries, as described with respect to the third stage 206.

At step 812, the method deploys the trained neural network language model on a hardware platform (e.g., hardware platform 660) as an artificial intelligence (AI) agent.

In some embodiments, method 800 is applicable in a variety of real-world applications that benefit from long-form or multi-step reasoning. For example, the task request received by a neural network model (e.g., trained target LLM 308) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like. Further, the neural network-based AI agent may enhance technologies across these various domains by enabling automated, multi-step reasoning previously limited to human experts, thus improving performance, efficiency, and scalability in decision support, planning, and analysis tasks.

For example, when the task query includes a query to identify an information technology (IT) anomaly relating to a usage of an IT component such as a network gateway, a router, an online printer, and/or the like, by performing method 800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface, or to generate a code script causing the network gateway to block traffic from suspicious Internet addresses. In this way, IT anomalies may be detected and alerted using the neural network based artificial agent in an efficient manner so as to improve network support technology.

### Example Results

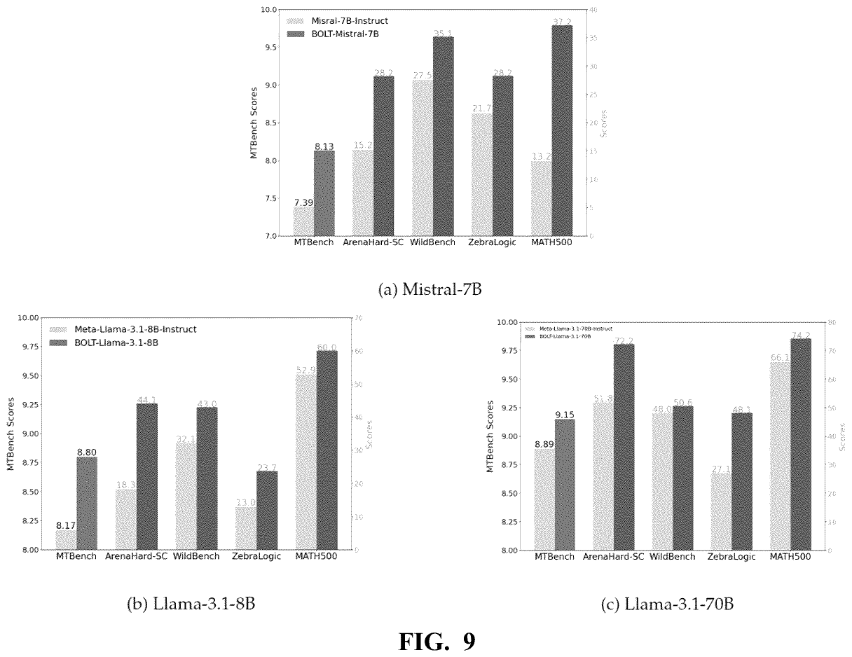

FIG. 9 represent exemplary test results using embodiments described herein. The test results demonstrate the effectiveness of the training framework 200 described herein (e.g., BOLT, which stands for Bootstrap Long Chain-of-Thought) across different large language models. Specifically, FIG. 9 shows the performance of Mistral-7B, Llama-3.1-8B, and Llama-3.1-70B models after applying the three-stage training process. The benchmarks used include Arena-Hard, MT-Bench, WildBench, ZebraLogic, and MATH500, which span diverse reasoning and problem-solving tasks such as mathematics, coding, logical reasoning, and general multi-turn queries. Across all model sizes, the trained models exhibit substantial improvements, validating that the proposed method effectively enhances long-form reasoning capabilities without relying on prior LongCoT models or distillation.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A computer-implemented method for training a target neural network language model to generate extended chain-of-thought reasoning, the method comprising:
receiving, one or more training input queries and one or more reasoning examples indicative of a first type of reasoning;
generating, via a plurality of inferences of a first neural network language model without being trained on training data of the first type of reasoning, a plurality of candidate reasoning responses having candidate reasonings compliant with the first type and their corresponding candidate answers, based on an input combining at least one training input query and the one or more reasoning examples as a context;
generating, by a reward model coupled to the first neural network language model, associated rewards indicative of an accuracy of the corresponding candidate answers;
selecting, for each input query, a single reasoning response from the candidate reasoning responses based on the associated rewards and a predefined reward threshold;
training the target neural network language model using the one or more training input queries and their corresponding selected reasoning response as ground truth for the first type of reasoning; and
deploying the trained target neural network language model on a hardware platform as an artificial intelligence (AI) agent.

2. The method of claim 1, wherein the first neural network language model is pretrained on training data of a second type of reasoning but not pretrained on training data of the first type of reasoning.

3. The method of claim 2, wherein the first type of reasoning includes a first sequence of tokens longer than a first threshold, and wherein the second type of reasoning includes a second sequence of tokens shorter than the first threshold.

4. The method of claim 3, wherein the first threshold includes a threshold number of tokens depending on a total number of tokens of a corresponding solution or a threshold number of steps of reasoning.

5. The method of claim 1, wherein each reasoning example comprises a triplet of query, reasoning of the first type, and solution.

6. The method of claim 1, further comprising:
generating, by the trained target neural network language model, one or more new reasoning responses to a new unseen input query;
generating, by the reward model, new reward scores for the new reasoning responses;
selecting a higher-scoring response and a lower-scoring response from the new reasoning responses based on the new reward scores; and
refining the trained target neural network language model using a preference optimization algorithm that increases a likelihood of generating the higher-scoring response relative to the lower-scoring response.

7. The method of claim 1, wherein the first neural network language model is the target neural network language model being trained.

8. The method of claim 1, wherein the first neural network language model is different from the target neural network language model being trained.

9. The method of claim 1, wherein the at least one training input query is selected from a curated set of queries generated by scoring and filtering an initial collection of queries across multiple task domains, the curated set comprising a higher proportion of instruction-type queries directed to math and coding tasks relative to other instruction types.

10. A system for training a target neural network language model to generate extended chain-of-thought reasoning, the system comprising:
a memory that stores one or more neural network models and a plurality of processor-executable instructions;
a communication interface that receives user input queries and reasoning examples indicative of a first type of reasoning; and
one or more hardware processors that read and execute the plurality of processor-executable instructions from the memory, wherein the plurality of processor-executable instructions are configurable to cause the system to perform operations comprising:
receiving, one or more training input queries and one or more reasoning examples indicative of a first type of reasoning;
generating, via a plurality of inferences of a first neural network language model without being trained on training data of the first type of reasoning, a plurality of candidate reasoning responses having candidate reasonings compliant with the first type and their corresponding candidate answers, based on an input combining at least one training input query and the one or more reasoning examples as a context;
generating, by a reward model coupled to the first neural network language model, associated rewards indicative of an accuracy of the corresponding candidate answers;
selecting, for each input query, a single reasoning response from the candidate reasoning responses based on the associated rewards and a predefined reward threshold;
training the target neural network language model using the one or more training input queries and their corresponding selected reasoning response as ground truth for the first type of reasoning; and
deploying the trained target neural network language model on a hardware platform as an artificial intelligence (AI) agent.

11. The system of claim 10, wherein the first neural network language model is pretrained on training data of a second type of reasoning but not pretrained on training data of the first type of reasoning.

12. The system of claim 10, wherein each reasoning example comprises a triplet of query, reasoning of the first type, and solution.

13. The system of claim 10, wherein the plurality of processor-executable instructions are configurable to further cause the system to perform operations comprising:
generating, by the trained target neural network language model, one or more new reasoning responses to a new unseen input query;
generating, by the reward model, new reward scores for the new reasoning responses;
selecting a higher-scoring response and a lower-scoring response from the new reasoning responses based on the new reward scores; and
refining the trained target neural network language model using a preference optimization algorithm that increases a likelihood of generating the higher-scoring response relative to the lower-scoring response.

14. The system of claim 10, wherein the first neural network language model is the target neural network language model being trained.

15. The system of claim 10, wherein the first neural network language model is different from the target neural network language model being trained.

16. A non-transitory machine-readable medium comprising a plurality of instructions, executable by one or more processors, wherein the plurality of instructions are configurable to cause the one or more processors to perform operations comprising:
receiving, by a first neural network language model, one or more training input queries and one or more reasoning examples indicative of a first type of reasoning;
generating, via a plurality of inferences of the first neural network language model without being trained on training data of the first type of reasoning, a plurality of candidate reasoning responses having candidate reasonings compliant with the first type and their corresponding candidate answers, based on an input combining at least one training input query and the one or more reasoning examples as a context;
generating, by a reward model coupled to the first neural network language model, associated rewards indicative of an accuracy of the corresponding candidate answers;
selecting, for each input query, a single reasoning response from the candidate reasoning responses based on the associated rewards and a predefined reward threshold;
training the first neural network language model using the one or more training input queries and their corresponding selected reasoning response as ground truth for the first type of reasoning; and
deploying the trained first neural network language model on a hardware platform as an artificial intelligence (AI) agent.

17. The medium of claim 16, wherein the first neural network language model is pretrained on training data of a second type of reasoning but not pretrained on training data of the first type of reasoning.

18. The medium of claim 17, wherein the first type of reasoning includes a first sequence of tokens longer than a first threshold, and wherein the second type of reasoning includes a second sequence of tokens shorter than the first threshold.

19. The medium of claim 18, wherein the first threshold includes a threshold number of tokens depending on a total number of tokens of a corresponding solution or a threshold number of steps of reasoning.

20. The medium of claim 16, further comprising:
generating, by the trained first neural network language model, one or more new reasoning responses to a new unseen input query;
generating, by the reward model, new reward scores for each of the new reasoning responses;
selecting a higher-scoring response and a lower-scoring response from the new reasoning responses based on the new reward scores; and
refining the trained first neural network language model using a preference optimization algorithm that increases a likelihood of generating the higher-scoring response relative to the lower-scoring response.
